(19) United States
(12) Patent Application Publication
(10) Pub. No.: US 2016/0178741 A1
(43) Pub. Date: Jun. 23, 2016

(54) BIDIRECTIONAL BISTATIC RADAR PERIMETER INTRUSION DETECTION SYSTEM

(71) Applicant: MICROSENSE SOLUTIONS LIMITED, Lisburn Antrim (GB)

(72) Inventors: Peter LUDLOW, Newcastle (GB); George REDPATH, Ballinderry (GB); Stephen SEAWRIGHT, Bangor (GB)

(73) Assignee: Sensurity Limited, Moira (GB)

(21) Appl. No.: 14/890,693

(22) PCT Filed: May 5, 2014
(86) PCT No.: PCT/EP2014/059057

§ 371 Date: Nov. 12, 2015

(30) Foreign Application Priority Data
May 12, 2013 (GB) 1308489.2

(51) Int. Cl. G01S 13/56; G01S 7/00; G08B 13/24; G01S 13/00

(52) U.S. Cl. CPC G01S 13/56; G01S 13/003; G01S 7/003; G08B 13/2491

(57) ABSTRACT

An intruder detection system comprising a pair of detection nodes supporting a bidirectional wireless communication link across which each node is capable of sending a wireless signal to and receiving a wireless signal from the other paired node. Each node analyses the wireless signal received from the other node to detect one or more characteristics of the received signal that is indicative of a target in the detection zone. Each node is operable in a transmit mode in which it transmits to the other paired node, and a receive mode in which it receives from said other paired node, each node switching periodically between modes.

### FIELD OF THE INVENTION

This invention relates to perimeter intrusion detection systems and, more particularly, to those that utilise a bistatic radar topology.

### BACKGROUND TO THE INVENTION

Microwave perimeter intrusion detection systems generally have one of two basic configurations, comprising either a bistatic or monostatic radar system. The IEEE defines bistatic radar as ‘a radar system that uses antennas at different locations for transmission and reception’. In the case of the bistatic angle between transmitter and receiver being equal to 180° the system may be described as a forward scatter (FS) radar. Typically in such systems a single transmitter is used at one side of a bistatic radar link and a single receiver at the other side of the link, for example as detailed in U.S. Pat. No. 3,877,002.

In a radar system the strength of the reflected signal from an object is dependent on the scattering properties of the object at the radar operating frequency, i.e. its radar cross section (RCS). The FS RCS of objects that are electrically large at a given frequency is significantly enhanced (relative to the backscattered or BS RCS) due to the effect of Babinet's principle.

A common problem in microwave bistatic radar perimeter intrusion detection systems is the false alarms that may result if processing of the received signal is not able to adequately distinguish an intruder from other fading effects. Also multipath signals may be difficult to observe in the presence of a large direct signal.

### SUMMARY OF THE INVENTION

A first aspect of the invention provides an intruder detection system as claimed in claim 1.

In preferred embodiments, false alarm reduction is achieved, and greater target information gathered, through the implementation of a bidirectional FS radar system, which involves using a transceiver at both sides of each link being protected.

Advantageously each detection node operates in half-duplex mode—such that they may both use the same frequency channel—and is switched between transmit and receive mode with a frequency greater than four times that of the maximum frequency content of the received multipath signal.

Advantageously, switching between transmit and receive modes allows a single antenna to be used at each node, which is useful with respect to maintaining small enclosure dimensions (thereby making the enclosure less visible to intruders). The RF architecture of the system is also simpler as a single half-duplex transceiver may be used, rather than a full-duplex transceiver, in each node.

Advantageously, using a bidirectional link enables simultaneous comparisons to be made with the stored database of intrusion signatures for each direction of transmission, thereby ensuring that the probability of false alarms being triggered is significantly reduced, and detection probability increased, compared with a typical unidirectional link.

Using a bidirectional FS radar helps to resolve the speed and baseline crossing point/angle values more precisely as simultaneous correlations can be made for each transmission direction, thereby enabling more accurate application of pattern recognition algorithms. Knowledge of the exact baseline crossing point/angle is useful with regard to interception of the target by on-site security as it pinpoints the exact location/direction of the intruder, which may be especially useful for links that have a long baseline length.

In preferred embodiments, comparing the received signal's amplitude variation for each direction of transmission allows the exact baseline crossing point to be determined.

A threshold process is advantageously used to determine if objects with RCS above a certain level have been detected within the detection zone of the link. If the variation in the RSSI (Received Signal Strength Indication) signal level is above this threshold then the target parameter/classification process may be triggered; also if a video camera, or other equipment, is linked to the system then recording of video footage of the link will commence. This means that the computational resources used by the system are minimised and current consumption thereby reduced, which is especially important for remotely positioned/battery powered nodes.

In some embodiments, the signal is transmitted in each direction across the link at different frequencies. This results in greater resolution of the nature of the target as its RCS differs with frequency and therefore the amplitude of the multipath signal scattered by the target differs for each transmission.

A second aspect of the invention provides an intruder detection method as claimed in claim

Preferred features of the invention are recited in the dependent claims.

Further advantageous aspects of the invention will be apparent to those ordinarily skilled in the art upon review of the following description of a preferred embodiment and with reference to the accompanying drawings.

### BRIEF DESCRIPTION OF THE DRAWINGS

An embodiment of the invention is now described by way of example and with reference to the accompanying drawings in which:

FIGS. 1(a) and 1(b) are alternative schematic views of a bidirectional bistatic radar system embodying one aspect of the invention and being suitable for use as an intruder detection system embodying another aspect of the invention;

FIG. 2 is a block diagram of a sensor node embodying a further aspect of the invention and being suitable for use in the bistatic radar system or intruder detection system of FIGS. 1(a) and 1(b);

FIG. 3 shows typical time-domain and frequency domain plots of RSSI variation as an intruder passes though a bidirectional bistatic radar link, for example of the intruder detection system of FIGS. 1(a) and 1(b);

FIG. 4 is a block diagram illustrating a preferred method of target crossing point evaluation in the intruder detection system of FIGS. 1(a) and 1(b) or other system supporting a bidirectional bistatic radar link;

FIG. 5 is a block diagram illustrating a preferred target detection method suitable for use in the intruder detection system of FIGS. 1(a) and 1(b) or other system supporting a bidirectional bistatic radar link;

FIGS. 6(a) and 6(b) are alternative schematic views of a dual frequency bidirectional bistatic radar system embodying one aspect of the invention and being suitable for use as an intruder detection system embodying another aspect of the invention; and

FIG. 7 is a block diagram illustrating a preferred target detection method suitable for use in the intruder detection system of FIGS. 6(a) and 6(b) or other system supporting a bidirectional multi-frequency bistatic radar link.

### DETAILED DESCRIPTION OF THE DRAWINGS

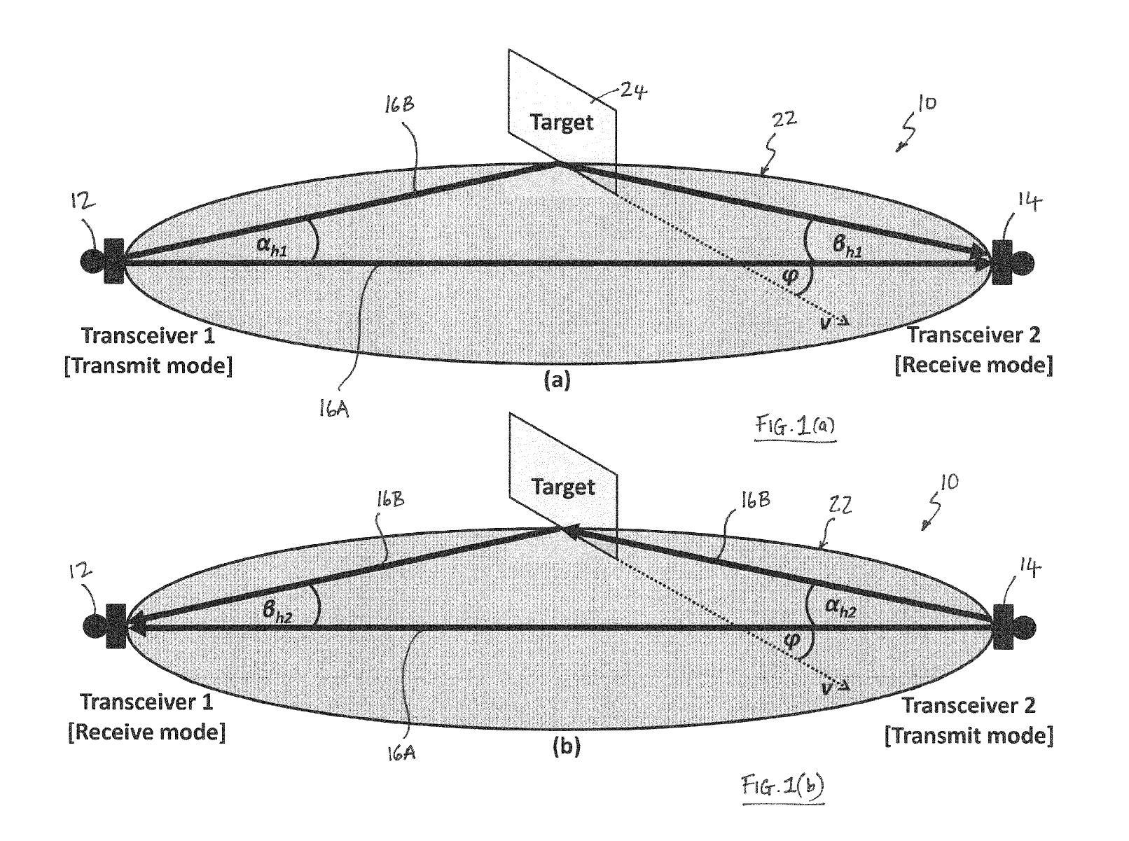

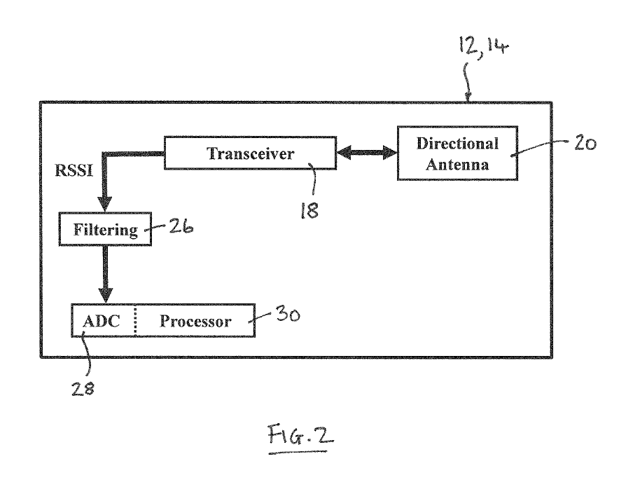

Referring now to FIGS. 1(a) and 1(b) of the drawings there is shown, generally indicated as 10, an intruder detection system. The system 10 comprises first and second spaced apart sensor nodes 12, 14, each node comprising a respective transceiver 18 (FIG. 2) for sending and receiving wireless signals 16 to or from the other node 14, 12 thereby creating a bidirectional wireless link between the nodes 12, 14. The nodes 12, 14 operate as a pair and, although FIG. 1 illustrates a single pair, other embodiments of the system 10 may comprise more than one pair of sensor nodes 12, 14. Hence, the system 10 may support more than one bidirectional wireless link.

Signals 16 that travel directly between the nodes 12, 14, i.e. without deflection, may be referred to as direct signals 16A and may be said to travel along a baseline between the nodes 12, 14. Signals 16 that reach the receiving node after deflection from an object in the detection zone may be referred to as multipath signals 16B. In preferred embodiments, the signals 16 comprise electromagnetic signals, typically in the radio frequency or microwave frequency range, and so the link may be described as a bidirectional bistatic radar link. The preferred intruder detection system 10 may therefore be said to comprise a bidirectional bistatic radar system. In preferred embodiments, a continuous wave (CW) wireless signal is transmitted between the nodes 12, 14, meaning that in the FS configuration a received signal will typically comprise a relatively strong direct signal 16A and a weaker multipath signal 16B, which modulates the amplitude and phase of the direct signal.

In the preferred system 10, the bistatic angle between the transmitter and receiver is 180° and so the system 10 may be described as a forward scatter (FS) radar system. In alternative embodiments of the invention, systems having other bistatic angles may be implemented.

Each node 12, 14 includes a respective antenna 20 (FIG. 2), the respective antennas being aligned with each other to define a detection zone 22. The antennas of FS radar systems typically have a relatively narrow beam width, for example having a 3 dB beamwidth of less than or equal to approximately 12°. Within the detection zone 22, the receiver section of each transceiver 18 is sensitive to, i.e. is capable of detecting, multipath signals scattered from a target 24 in the zone 22. To achieve a suitable receiver sensitivity the ratio of the strength of a direct signal between the nodes 12, 14 to the strength of multipath signals scattered from the target 24 is typically less than a given threshold, for example approximately 30-40 dB. The shape and dimensions of the detection zone 22 are a function of any one or more of: (i) target RCS, as an electrically larger target will have a higher value/narrower beam width FS RCS lobe, (ii) target height, as propagation loss for target scattering is inversely related to (target height)̂4 for ground links, (iii) link length, as the propagation loss for target scattering is proportional to (link length)̂8 in a ground link, and (iv) antenna gain, as a narrow beam width/low side lobe level transmit/receive antenna will focus transmitted signals/be sensitive to multipath scattered signals within a narrower volume of space.

In use, an object (i.e. target 24) passing through the detection zone 22 interferes with the electromagnetic field associated with the bistatic radar link and this results in detectable changes (which may be referred to as a signature) in the output signal from the antenna 20 at the receiving node 12, 14. Hence, as the target 24 moves through the detection zone 22 a unique signature is detectable in the receiving antenna output, typically as a result of amplitude and phase modulation caused in the received signal by the object's movement. The signature may be evaluated using analogue and/or digital signal processing techniques to determine if an intrusion has occurred.

FIG. 2 shows an embodiment of the sensor nodes 12, 14. Each node 12, 14 comprises an antenna 20, preferably a directional antenna, capable of sending and receiving signals via the wireless link between the nodes 12, 14. In preferred embodiments, the antenna 20 is configured to send and receive signals in one or more applicable radio and/or microwave frequency bands. The transceiver 18 is coupled to the antenna 20 for sending signals to the antenna 20 when in transmit mode, and receiving signals from the antenna 20 when in receive mode. In preferred embodiments, the transceiver 18 is configured to send and receive signals in one or more applicable radio and/or microwave frequency bands. Typically, the transceiver comprises a superheterodyne transceiver and, as appropriate, is operable to up/down convert IF signals to RF signals. When in receive mode, the transceiver 18 is preferably configured to produce an output signal comprising an RSSI (Received Signal Strength Indicator) signal.

The output of the transceiver 18 is provided to a filter 26 for removing unwanted components of the transceiver output. The filter 26 typically comprises a high-pass filter (to eliminate low-frequency clutter signals from, for example, vegetation or rainfall) and a low pass filter (usually with a cut off frequency more than twice that of the maximum frequency content of the scattered multipath signal). An analogue-to-digital converter (ADC) 28 is provided for sampling the (filtered) output signal. The resulting digitised transceiver output signal is provided to a processor 30 for analysis. The processor 30 may comprise a suitably programmed microprocessor, microcontroller or other digital signal processing (DSP) device. As is described in more detail hereinafter, the processor 30 is configured to detect the presence of an intruder in the detection zone 22. The transmit section of the transceiver 18 may take any convenient conventional form.

In receive mode, the node 12, 14 may distinguish a received multipath signal from a received direct signal by using variations in RSSI levels to evaluate intrusions. For example, for a direct signal the RSSI remains at a relatively high and constant level, whereas for multipath signals the RSSI level varies. The filter 26 may be configured to remove the dc content in the RSSI signal in order that only variations in RSSI level are analysed.

Optionally, each node 12, 14 is configured to implement low bitrate amplitude shift keying (ASK) or frequency shift keying (FSK) modulation to uniquely pair the, or each, pair of transceiver nodes 12, 14 present in the system 10 via transmission of a unique identifier code between the paired nodes 12, 14.

Advantageously, the system 10 reduces the incidence of false alarm detection, and gathers more target information than a conventional system, through the implementation of a bidirectional FS radar system comprising a transceiver at both sides of the, or each, bidirectional link supported by the system 10.

In the preferred embodiment, the respective nodes 12, 14 (and in particular their respective transceiver 20) of a pair switch at intervals between operating in receive mode and in transmit mode so that at any given time, one is operating in receive mode and the other is operating in transmit mode. In preferred embodiments, switching between transmit and receive modes occurs continuously, irrespective of whether a target is present in the detection zone of the link. The system 10 therefore has a first operating state (illustrated in FIG. 1(a)) in which the first node 12 operates in transmit mode and the second node 14 operates in receive mode, and a second operating state (illustrated in FIG. 1(b)) in which the first node 12 operates in receive mode and the second node 14 operates in transmit mode. The switching between operating states is conveniently performed periodically, preferably at a frequency greater than four times that of the maximum frequency content of the received multipath signal. This enables each channel to comply with the Nyquist sampling theorem, i.e. sampling of the RSSI variation at twice the rate of its maximum frequency content. Advantageously, the respective transceivers 20 (and more generally the respective nodes 12, 14) operate in a half-duplex mode such that they may each use the same frequency channel to communicate with one another. The nodes 12, 14 may communicate with one another by any convenient means (not shown) to synchronise switching between respective transmit and receive modes. For example, the nodes may be linked by Ethernet in which case the Precision Time Protocol, defined in the IEEE 1588 standard, may be used for synchronisation of switching. This allows sub-microsecond synchronisation. Alternatively, a GPS module (not shown) may be provided in each node 12, 14 to allow synchronisation with atomic clocks on GPS satellites, which means synchronisation accuracy at the GPS module of typically 100 nanoseconds or less. Either of these techniques, or any other convenient technique, may be implemented in the system using readily available off-the-shelf components.

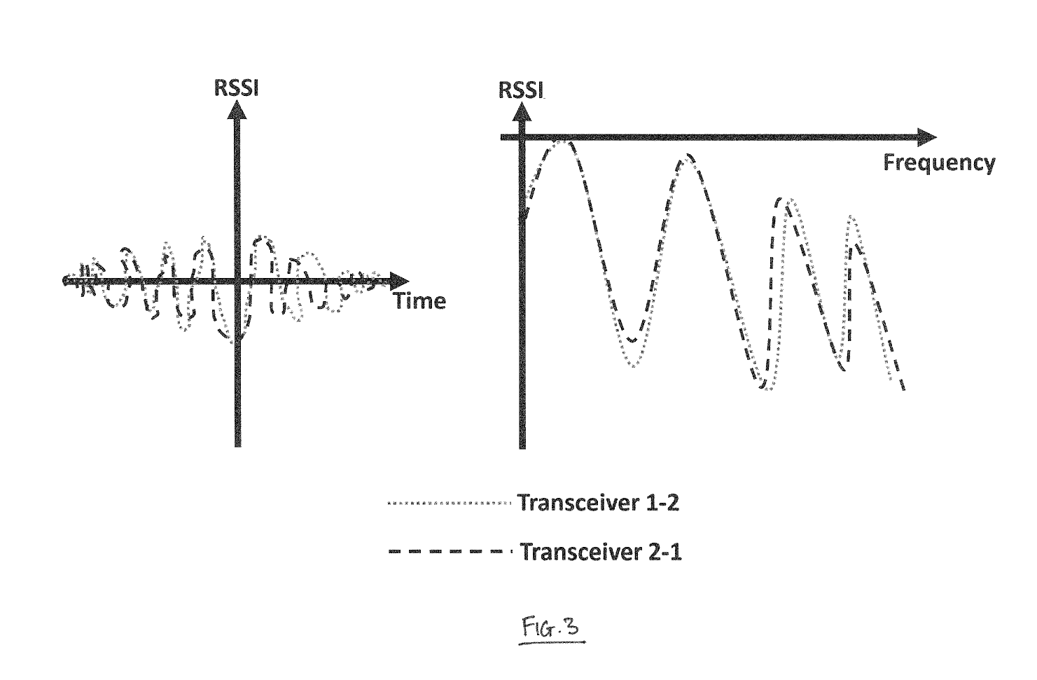

The target signatures may comprise plots (or other representation) of signal power, conveniently normalised received signal power, versus target frequency, conveniently Doppler frequency (where Doppler frequency describes the variation in the frequency of the received multipath signals over time), as shown in the right-hand plot of FIG. 3. The signal power values may be normalised to the maximum power level in the signal. The instantaneous Doppler frequency defined in equation [1] below corresponds to a single point on the x-axis of this plot which, for a target moving at a certain speed and for a known radar operating wavelength, will correspond to the position of a target relative to the transmitter and receiver. The normalised signal power amplitude (on the y-axis) depends on the amplitude of the received signal for this target position, which is dependent on target RCS/target height/link length/antenna gain.

The characteristics of the frequency domain, or Doppler frequency, plots used for pattern recognition are dependent on the feature extraction technique used. The frequency characteristics may be assigned automatically using for example Principle Component Analysis, which reduces the dimensionality of the frequency domain signatures down to Principle Components, the number of which may be chosen by the user. Alternatively the characteristics may be manually extracted, e.g. first main lobe width, second main lobe width, and/or number of lobes below a set threshold frequency. In the manual extraction technique the lobe widths and number of lobes are primarily affected by variations in the received signal level due to how the radar cross section of the target varies for particular target-receiver angles, βₕ(t)—radar cross section nulls occur at particular angles, corresponding to nulls at particular instantaneous Doppler frequencies as each instantaneous Doppler frequency corresponds to a target position relative to transmitter/receiver.

With reference to FIGS. 1(a) and 1(b), the instantaneous Doppler frequency of the scattered multipath signal 16B created as the target 24 moves through the detection zone 22 of a FS radar system is determined by the target's speed, v, the wavelength, λ, of the continuous wave signal used in the system, the angles from transmitter to target, αₕ(t), and from receiver to target, βₕ(t), and the baseline crossing angle, φ:

$${f}_{d} ( t ) = \frac{2 v}{λ} sin [ \frac{{α}_{h} ( t ) + {β}_{h} ( t )}{2} ] sin [ φ + \frac{{α}_{h} ( t ) - {β}_{h} ( t )}{2} ] \qquad [ 1 ]$$

Therefore the maximum frequency content B of the multipath signal is:

$$B = \frac{2 v}{λ} \qquad [ 2 ]$$

It is evident from equation [2] that for objects moving at higher speeds, and/or systems that operate using higher frequency continuous wave signals, the bandwidth of the multipath signals created by the target (intruder) are relatively high and pose more constraints on the architecture proposed above, since the transceiver 20 has to switch more quickly between the transmit and receive modes.

In the case of detecting human intruders it may be presumed that their speed will be less than 10 m/s and therefore, for system operation at 5.8 GHz for instance, the multipath signal bandwidth will be less than 387 Hz. Sampling at a rate of more than 774 Hz is therefore required for each channel (i.e. in each of the alternate operating states of the system 10), meaning that the respective transceivers 20 at each side of the link have to switch between transmit and receive modes approximately every 0.65 ms or less to enable sampling at this rate for each direction of transmission across the link. A constraint on transmit/receive switching time is the lock-time of a phased lock loop (PLL) device (not illustrated) that is typically used to generate local oscillator signals in the transceiver 20 for up/down conversion. However, a switching period of 0.65 ms is feasible assuming that the loop filter used in the PLL has a relatively wide bandwidth to enable relatively fast loop lock-times.

In bistatic radar intrusion detection systems, target detection may be performed using threshold analysis, e.g. determining if the movement of the target 24 through the direct path of the link has led to a drop greater than a threshold value in the amplitude of the received signal in the time domain, conveniently the RSSI amplitude, meaning that a target with an RCS greater than a threshold value has passed through the link. It is noted that the target does not necessarily have to cross the baseline of the link for it to cause a drop in the RSSI greater than the threshold value set at the receiver for target detection. For example, for relatively large metal objects such as cars (with a large RCS) moving adjacent to the link, but not through the baseline, the RSSI may drop by an amount greater than the threshold value (which is typically set for smaller targets, such as people, with smaller RCS moving through the baseline of the link).

Hence, a simple threshold detection method is vulnerable to false alarms since multipath signals received from outside of the direct path may also cause signal amplitude drops of greater than the threshold value. Also, relatively subtle changes in the received signal caused by movement of a low RCS target, such as a crawling person, through the link may not be detected. In preferred embodiments of the invention, (RSSI) threshold analysis is used to trigger subsequent target detection, for example application of signal processing algorithm(s), in order to classify the target that caused the RSSI change with greater accuracy and fewer false alarms.

To reduce false alarm probability, and increase detection probability for low RCS targets, preferred embodiments employ one or more pattern recognition algorithm to analyse the received signal, in particular the received multipath signal(s). Conveniently, the processor 30 is programmed to implement one or more pattern recognition algorithm. This may involve comparing one or more characteristics of the received multipath signal(s) (which may be said to be represented by a signature of the respective signal) with one or more of a plurality of stored comparable signatures (i.e. data representing one or more corresponding characteristics of a plurality of reference signals) that represent respective identifiable events, such as intrusion events or false alarm events. The stored signatures may be stored in local memory (not shown) in each node.

Multipath signals caused by a target between the nodes 12, 14 are received in the time domain with a “signature” amplitude and phase variation. For the purposes of analysis, it is convenient to convert time domain multipath signals to the frequency domain, e.g. using FFTs, thereby creating a corresponding frequency signature for the target 16. The stored signatures for comparison with the frequency signatures obtained from the received multipath signal conveniently also comprise corresponding frequency domain signatures that facilitate comparison by signal processing. The frequency signatures preferably comprise Doppler frequency signatures.

In preferred embodiments, prior to comparison of the received signatures with the stored signatures, pre-processing of the received frequency signatures is advantageously performed to normalise them to a reference target speed and also to the maximum power level in the received signal. Also the baseline crossing point/angle is preferably evaluated to reduce the number of stored frequency domain signatures with which comparison is to be made, i.e. for particular intervals of baseline crossing point/crossing angle, frequency domain signatures of target types are stored. The pre-processing may involve an autocorrelation process, which compares the phase variation in the received time domain signal with that expected for a particular target speed, baseline crossing point and baseline crossing angle.

Pattern recognition algorithms well known to one skilled in the art, for example involving a neural network approach or a principle component analysis/K-nearest neighbour approach, may be used.

In any event, the use of pattern recognition algorithms enables determination of intrusion with a high level of accuracy. Using a bidirectional link enables simultaneous comparisons to be made with the stored database of intrusion signatures for each direction of transmission, thereby further reducing the probability of false alarms, and increasing detection probability increased, compared with a typical unidirectional link.

From equation [1], the target's frequency signature, in particular its Doppler signature, is dependent on its speed, baseline crossing point and baseline crossing angle. In preferred embodiments, prior to any comparisons with reference intruder signatures stored in the database, the processor 30 performs a pre-processing process to normalise the received Doppler signatures to a selected (or reference) target speed. The processor 30 also determines a baseline crossing point and baseline crossing angle for the target 16. This allows the number of database signatures that the detected signature should be compared with to be reduced.

In preferred embodiments, the stored reference signatures comprise respective Doppler signatures for a plurality of target types (e.g. a person running, walking, jumping, commando rolling, crawling on hands and knees or belly crawling), and optionally one or more anticipated false alarm Doppler signatures (e.g. representative of a small animal walking or a bird/flock of birds flying through the link, especially when close to either node, or a car moving parallel to the link), respective such reference signatures preferably being stored for respective intervals of baseline crossing point/crossing angle.

In order to determine a baseline crossing point and baseline crossing angle for the target 16, an autocorrelation process may be employed, typically by processor 30, to correlate an expected phase variation in the received signal as a target moves through the detection zone with a given speed and baseline crossing point/angle (as predicted in equation [1]) with that observed. Expected phase variation may be obtained from any one or more of a plurality of reference signal data.

Advantageously, the bidirectional aspect of preferred embodiments of the invention helps to resolve the speed and baseline crossing point/angle values more precisely as simultaneous pre-processing correlations can be made for each transmission direction, thereby enabling more accurate application of pattern recognition algorithm(s). Knowledge of the exact baseline crossing point/angle is useful with regard to interception of the target by on-site security as it pinpoints the exact location/direction of the intruder, which may be especially useful for links that have a long baseline length.

FIG. 3 shows typical time-domain and frequency domain plots (one for each transmission direction: transceiver 1-2 and transceiver 2-1 respectively) of the received signal, in particular the RSSI signal, as an intruder (target 24) walks through the bidirectional link between nodes 12, 14. The amplitude envelope of the time-domain signal varies according to any one or more of: the propagation loss (which is greater for lower target height, a longer link length and baseline crossing points closer to the link centre), target RCS and antenna beam width. For example, as the intruder moves closer to the baseline their FS RCS increases considerably due to Babinet's principle (assuming their cross section is electrically large at the radar operating frequency) and the transmit/receive antenna gain that is illuminating/viewing the target also increases. The phase shift of the time-domain signal is due to the varying propagation path (from transmitter to target to receiver) length, as detailed in equation [1] as the target moves through the detection zone. The RSSI variation for each signal path (transceiver 1-2 and transceiver 2-1 respectively) is generally similar for narrower target viewing angles (low values of αₕ(t) and βₕ(t)). With regard to the frequency-domain variations, the frequency resolution is equal to the sampling or observation time divided by the sampling rate.

The target's RCS varies with the viewing angle from the transmitter, αₕ(t), and receiver, βₕ(t), for targets that are relatively large electrically since the FS RCS lobe will be at differing angles from the receiving node 12, 14. For targets that are relatively large electrically, where the optical RCS scattering approximation holds true and the forward scattered main lobe is relatively narrow, significant variation in the target's RCS as viewed from the receiving node 12, 14 occurs. This causes the amplitude modulation of the received multipath signal to vary depending on link transmission direction and may be used as a further criterion for evaluating baseline crossing point. The previously mentioned pre-processing, which correlates the actual phase of the received signal with that expected, can only determine that an intrusion occurred at a certain distance from the midpoint of the baseline of the link, as the phase variation in the time domain for targets moving symmetrically with respect to the midpoint is identical; however by comparing the received signal's amplitude variation for each direction of transmission the exact baseline crossing point may be determined.

Since the transmit power, transmit/receive antenna gain, operating frequency and path loss are identical for each direction of transmission across the link it is only target RCS variation which causes a variation between the received signal amplitude envelope for each transmission direction. The target RCS at the baseline is equal to 4πS²/λ², but is lower for target positions off-baseline and varies according to:

(i) The target area projected onto the direct transmitter-target line of sight, which varies depending on the target's baseline crossing angle, φ, and the angle between transmitter and target, αₕ(t).

(ii) The equivalent radiation pattern of the target, which may be treated as a secondary antenna; this may be approximated by a sinc(x) function, with x having a dependence on αₕ(t) and φ.

When the target 24 crosses the baseline at a distance from the baseline midpoint it has a different transmitter viewing angle variation with time, αₕ(t), for the transceiver 1-2 link (FIG. 1(a)) and transceiver 2-1 link (FIG. 1(b)). Since φ can be calculated using the autocorrelation process described above, the effect of αₕ(t) on the target RCS, and thereby on the received power level (RSSI level), may be calculated for each of the possible baseline crossing points determined in the phase-based pre-processing step. For each possible baseline crossing point it may therefore be predicted whether the received signal amplitude envelope should be higher for the transceiver 1-2 link or the transceiver 2-1 link. The variation in the target's RCS for each transmission direction may thus be evaluated through a pre-processing comparison of the amplitude envelope of the respective received signals, after the effect of baseline crossing angle, φ, has been accounted for.

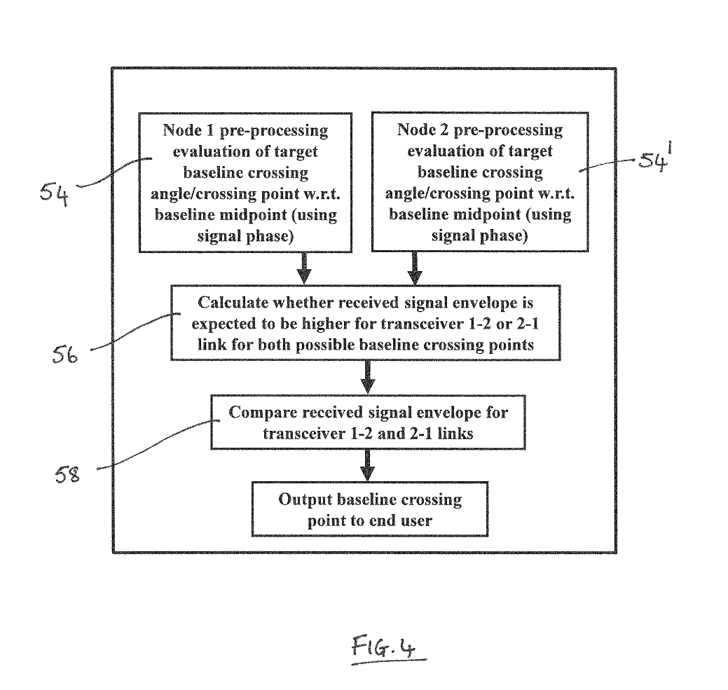

A preferred crossing point evaluation method is described in FIG. 4. In blocks 54, 54′ in respect of the same target, each node 12, 14 (typically the respective processor 30) determines a base line crossing point data (typically including distance from node and crossing angle) for the target 24. Conveniently, this may be achieved using the autocorrelation pre-processing technique described above. In block 56, either one or both of the nodes 12, 14 calculates in respect of which transmission direction the amplitude (e.g. RSSI level) of the received signal is expected to be higher based on the respective predicted crossing point data. In block 58, either one or both of the nodes 12, 14 compares the respective amplitudes of the actual received signals at each node 12, 14 and determines which is higher. This allows the or each node 12, 14 to resolve the actual baseline crossing point with respect to the base line midpoint. The decision at block 58 may just involve deciding at which side of the baseline midpoint the target has crossed. The pre-processing described in relation to block 48 allows determination of the distance from the link midpoint that crossing occurred. Any suitable data link between the nodes 12, 14, or back to a central server or computer terminal, is provided to enable simultaneous assessment using the received signals from both nodes 12, 14.

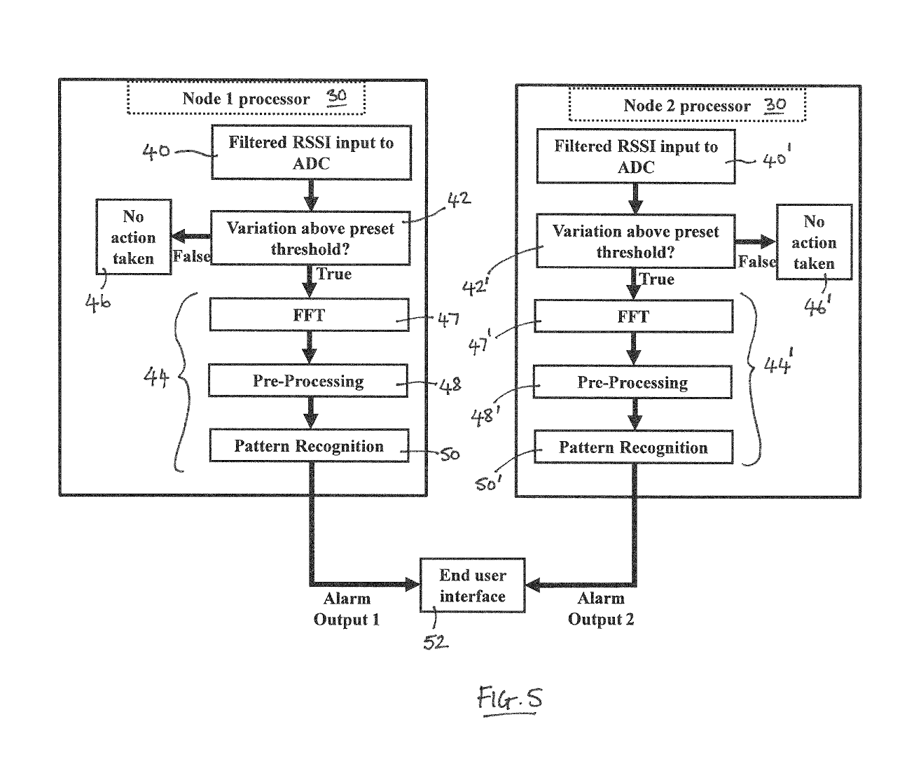

FIG. 5 shows a block diagram of the preferred detection process used by each node 12, 13 in the evaluation of received signals, the process conveniently being performed by the respective processor 30. Block 40, 40′ represents the received signal being provided to the processor 30, which in this example is assumed to have been filtered and digitised. It is also assumed in this example that the received signal is provided as, or at least comprises, an RSSI signal. At block 42, 42′, the received signal is subjected to a threshold analysis to determine if a target 24 with an RCS above a certain level has been detected within the detection zone 22 of the link supported by the nodes 12, 14. The threshold analysis involves comparing a characteristic, typically the amplitude, of the received signal (in this case the RSSI signal, in particular the filtered RSSI level since it is the RMS amplitude of the ac content in the RSSI signal that is assessed in the preferred embodiment) against a threshold value. It is preferred to analyse variations in the multipath signal strength (RSSI level in this example) using RMS values. If the RMS amplitude exceeds the threshold value for a given measurement period of, for instance, 0.1 seconds then it is assumed that an object has been detected in the detection zone.

If the RSSI RMS level is determined to be above the threshold this indicates that an object has been detected in the detection zone 22 and, in preferred embodiments, the target analysis process 44, 44′ is initiated, otherwise it is determined that no object is detected (block 46, 46′). In cases where the system 10 includes one or more activatable detection or monitoring devices, for example one or more video cameras for monitoring the detection zone 22 (or elsewhere), such devices may be activated in response to the detection of an object at block 42, 42′. As a result, the computational resources used by the system are minimised and current consumption thereby reduced, which is especially important for remotely positioned and/or battery powered nodes.

The preferred target analysis process 44, 44′ involves a transform, conveniently a Fast Fourier Transform, of the received time domain signal into the frequency domain (block 47, 47′). The pre-processing procedure (block 48, 48′) is then employed to normalise the speed and baseline crossing point/angle to reference values, to facilitate comparison of the received signal with the stored signatures (block 50, 50′). This may involve the use of conventional pattern recognition algorithms such as neural network analysis or principle component/K-nearest neighbour analysis. A decision is made, based on the result of this process, to determine whether to cause an alarm signal to be rendered to an end user via any suitable interface 52 (e.g. comprising one or more visual and/or audio output device). Advantageously, simultaneous processing of the received signal at each node 12, 14 for each transmission direction increases the probability of valid target detection and the probability of false alarms is reduced.

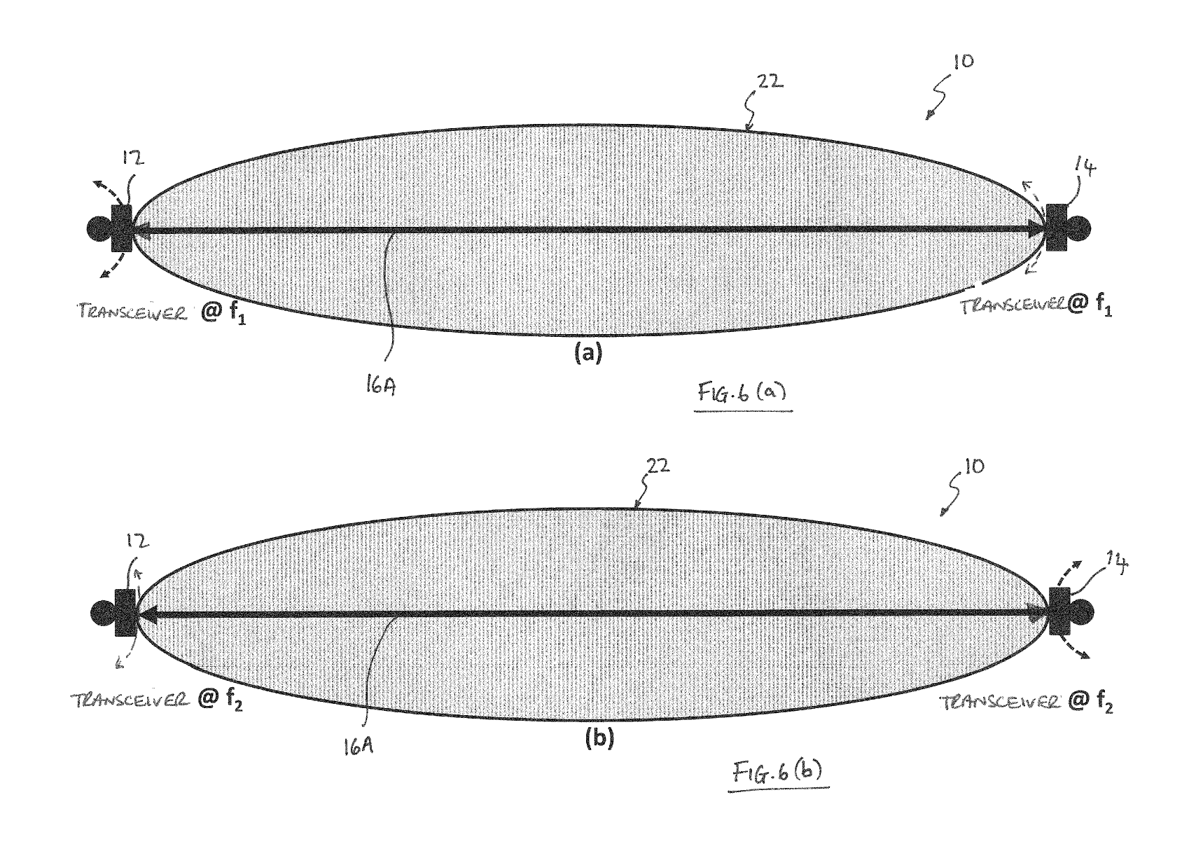

In an alternative embodiment illustrated in FIGS. 6(a) and 6(b), each node 12, 14 of a pair is configured to transmit and receive signals at each of first and second different frequencies (f1, f2). This allows better resolution of the nature of the target 24 since its RCS differs with frequency and therefore the amplitude (and/or other characteristics) of the multipath signal scattered by the target 24 differs for each transmission direction. Preferably, the arrangement of each node is such that each transmission direction supports transmission and reception at both frequencies. Alternatively, the arrangement may be such that each node sends at one frequency and receives at another—i.e. each transmission direction has a different frequency. To enable transmission/reception at different frequencies simultaneously, a respective transmitter and receiver (or transceiver), and respective antennas, are typically required at each node 12, 14 for each frequency of operation. Communication between nodes 12, 14 is preferably full duplex in multi-frequency embodiments. However, half-duplex communication may be employed in embodiments where one tuneable transceiver is provided at each node 12, 14 and switching is effected not only between transmission directions but also frequencies.

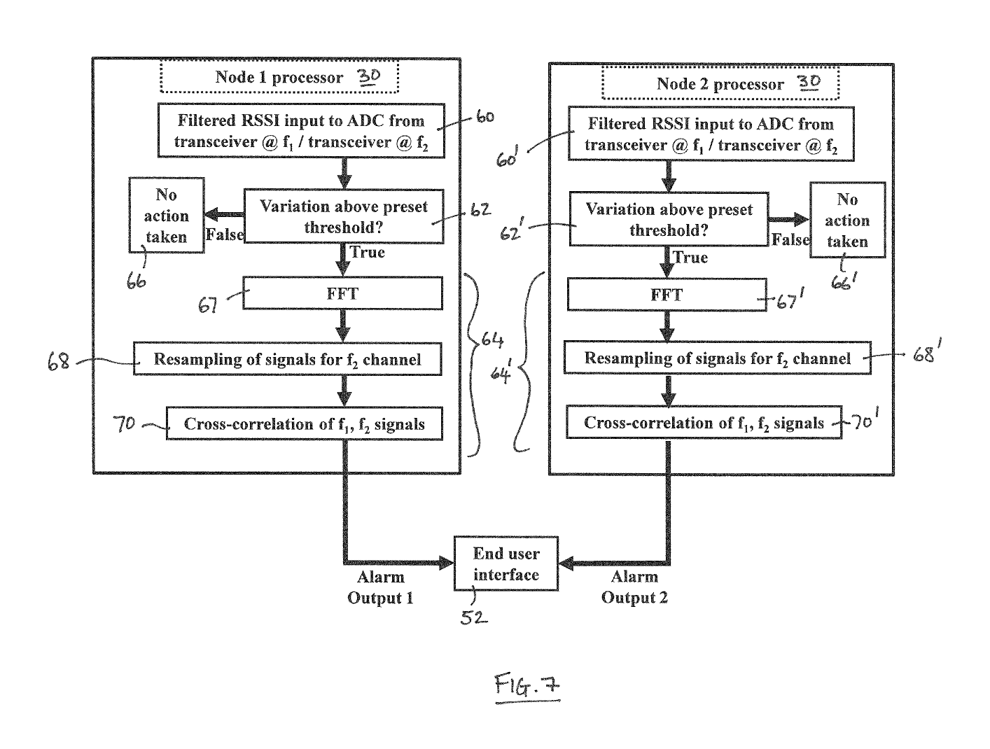

Advantageously, at each node 12, 14 cross-correlation of the respective received signal at each frequency (using any convenient conventional cross-correlation technique) is performed, typically after resampling of the signal, which is necessary as the time/frequency domain occupancy of the received signals at the respective frequencies will vary. In the example of FIG. 7 only the f2 channel is resampled at each side of the link. The received signal in the f2 channel may be considered as the compressed version in the time domain of the signal at the lower frequency, while it has a higher Doppler signature bandwidth (as shown in [1] the Doppler frequency is proportional to operating frequency). Resampling of the signature at the highest frequency may be used to give a more similar Doppler signature bandwidth and therefore improve signal compression gain in correlation of the signatures at each frequency. The resampling factor may be found through experimentation and used thereafter in the operation of the link, with the resampling factor that gives the highest compression gain in correlation of target signatures for each frequency being the one that is used.

When the cross-correlation of the received signals at the respective frequencies f1, f2 produces a cross-correlation value that is above a preset threshold (indicating that the respective signals are sufficiently similar to one another) at any one of and preferably both sides of the link, this indicates the presence of a target 24 passing through the baseline of the link (it may be presumed that clutter/interfering signals are de-correlated for each frequency). Targets that pass through the baseline of the link have a higher cross-correlation due to the greater effect on received signal amplitude when the target passes through the baseline, rather than through part of the detection zone but not through the baseline. The threshold for cross-correlation is preferably set to recognise target movement through the link baseline. The bidirectional aspect of the link allows more accurate determination of whether a target 24 has intruded or not, as the cross-correlation process may be carried out at both sides of the link, thereby giving less probability of clutter, interfering signals or movement of people/large reflectors such as cars near to, but not through the baseline of, the link triggering an alarm.

FIG. 7 shows a block diagram of the preferred detection process used by each node 12, 14 in the evaluation of received signals in the multi-frequency embodiment, the process conveniently being performed by the respective processor 30. Block 60, 60′ represents the received signal being provided to the processor 30, which in this example is assumed to have been filtered and digitised. It is also assumed in this example that the received signal is provided as, or at least comprises, an RSSI signal. At block 62, 62′, the received signal is subjected to a threshold analysis to determine if a target 24 with an RCS above a certain level has been detected within the detection zone 22 of the link supported by the nodes 12, 14. The threshold analysis involves comparing a characteristic, typically the amplitude, of the received signal (in this case the RSSI signal) against a threshold value. It is preferred to analyse variations in the multipath signal strength (RSSI level in this example) using RMS values. If the RMS amplitude exceeds the threshold value for a given measurement period of, for instance, 0.1 seconds then it is assumed that an object has been detected in the detection zone. If the RSSI signal level is above the threshold this indicates that an object has been detected in the detection zone 22 and, in preferred embodiments, the target analysis process 64, 64′ is initiated, otherwise it is determined that no object is detected (block 66, 66′). In cases where the system 10 includes one or more activatable detection or monitoring devices, for example one or more video cameras for monitoring the detection zone 22 (or elsewhere), such devices may be activated in response to the detection of an object at block 62, 62′. The preferred target analysis process 64, 64′ involves a transform, conveniently a Fast Fourier Transform, of the received time domain signal into the frequency domain (block 67, 67′). At block 68, 68′ any necessary resampling is performed. In this example the received signal at the second frequency f2 is resampled. At block 70, 70′ the respective signals at frequencies f1, f2 are cross-correlated. A decision is made, based on the result of this process, to determine whether to cause an alarm signal to be rendered to an end user via any suitable interface 52 (e.g. comprising one or more visual and/or audio output device). Optionally, an intruder event may be detected (and an alarm signal generated) depending on the cross-correlation performed by either one of the nodes 12, 14, although the detection is deemed to be more robust if both nodes detect it. It is noted that the above-described correlation of signals at different frequencies may be employed in a uni-directional detection system.

The cross-correlation method described above may be used for target detection without having to carry out the pre-processing and pattern recognition process described with reference to FIG. 5.

In multi-frequency embodiments, system alignment—which helps to ensure that received power is maximised and to prevent interference with adjacent links—may be carried out using both frequency channels, which, if they are adequately separated in frequency, may be assumed to be fading-independent. Accordingly alignment is less susceptible to fading effects caused by the conditions during system installation, e.g. the presence of any nearby large reflectors such as parked vehicles will not influence the alignment process.

The invention is not limited to the embodiment(s) described herein but can be amended or modified without departing from the scope of the present invention.

1. An intruder detection system comprising at least one pair of detection nodes, each node comprising wireless communication means for supporting a bidirectional wireless communication link across which each node is capable of sending a wireless signal to and receiving a wireless signal from the other paired node, said wireless signals creating, in use, an electromagnetic field defining a detection zone between the paired nodes, and wherein each node of a pair comprises analysing means for analysing said wireless signal received from the other node of the pair to detect one or more characteristics of said received signal that is indicative of a disturbance in said electromagnetic field caused by the presence of a target in said detection zone.

2. A system as claimed in claim 1, wherein each node is operable in a transmit mode in which it transmits said wireless signal to said other paired node, and a receive mode in which it receives said wireless signal from said other paired node, the system further including control means configured to cause one node of the pair to operate in the transmit mode while the other node of the pair operates in the receive mode, and to cause each node of the pair to switch between modes wherein, preferably, said control means is configured to cause each node of the pair to switch between modes periodically, optionally at a frequency greater than four times the maximum frequency of said received signal.

3. (canceled)

4. (canceled)

5. A system as claimed in claim 2, wherein, when said target is in said detection zone, said received signal includes a multipath signal reflected from said target, and wherein said control means is configured to cause each node of the pair to switch between modes at a frequency greater than four times the maximum frequency of said multipath signal.

6. A system as claimed in claim 1, wherein each node is configured to transmit said wireless signal at the same frequency.

7. A system as claimed in claim 1, wherein each node is configured to transmit said wireless signal at a respective different frequency, and wherein at least one, and preferably each, node is optionally configured to transmit said wireless signal at at least two different frequencies, preferably the same two different frequencies.

8. (canceled)

9. (canceled)

10. A system as claimed in claim 7, wherein said analysing means of at least one node of a pair is configured to cross-correlate respective received signals resulting from wireless signals transmitted from the other paired node at first and second different frequencies, said system determining, in use, if said target is detected depending on said cross-correlation, and wherein, optionally, said at least one node includes means for resampling at least one of said respective received signals prior to said cross-correlation.

11. (canceled)

12. A system as claimed in claim 10, wherein said analysing means of each node of a pair is configured to cross-correlate respective received signals resulting from wireless signals transmitted from the other paired node at first and second different frequencies, said system determining, in use, if said target is detected depending on said cross-correlation.

13. A system as claimed in claim 10, wherein the cross-correlation of respective received signals resulting from wireless signals transmitted from the other paired node at first and second different frequencies involves a comparison of the received signals to each other, and wherein said system is optionally configured to determine if said target is detected depending on the similarity between said received signals determined by said comparison.

14. (canceled)

15. A system as claimed in claim 1, wherein the analysing means of one or both nodes of a pair is configured to measure the strength of said received signal and to determine if said target is detected depending on said measurement.

16. A system as claimed in claim 15, wherein, when said target is in said detection zone, said received signal includes a multipath signal reflected from said target, and wherein the analysing means of one both nodes of a pair is configured to measure the strength of said multipath signal and to determine if said target is detected depending on said measurement.

17. A system as claimed in claim 15, wherein, in response to, and preferably only in response to, detection of a target by said measurement of received signal strength, the analysing means of one or both nodes of a pair, and/or other system components, are configured to perform analysis of said received signal.

18. A system as claimed in claim 1, wherein the analysing means of one or both nodes of a pair is configured to correlate an expected phase of said received signal with an actual phase of said received signal.

19. A system as claimed in claim 1, wherein the analysing means of one or both nodes of a pair is configured to compare at least one characteristic of said received signal with one or more corresponding characteristics of a plurality of reference signals, and to match said received signal to one or more of said reference signals based on said comparison, and wherein the analysing means of one or both nodes of a pair is optionally configured to classify the received signal as one or more of a plurality of intrusion types based on said matching, and wherein said comparison and matching optionally involves application of one or more pattern recognition algorithms.

20. (canceled)

21. (canceled)

22. A system as claimed in claim 19, wherein prior to said comparison, said analysing means is configured to normalise said received signal to a reference target speed and preferably also to the maximum power level in the received signal.

23. A system as claimed in claim 19, wherein prior to said comparison said analysing means is configured to determine the baseline crossing data, preferably comprising a baseline crossing point and a baseline crossing angle, and wherein said analysing means is optionally configured only to performed said comparison for a subset of said reference signals corresponding to said determined baseline crossing data, and wherein determining said baseline crossing data optionally involves comparing the phase variation in the received time domain signal with a respective expected phase variation for one or more reference target speed, baseline crossing point and/or baseline crossing angle.

24. (canceled)

25. (canceled)

26. A system as claimed in claim 19, wherein said analysing means is configured to operate on, and create as necessary, a respective frequency representation of said received signal, preferably a Doppler signature.

27. A system as claimed in claim 26, wherein said analysing means is configured to operate on, and create as necessary, a respective frequency representation of said reference signals, preferably a Doppler signature.

28. A system as claimed in claim 27 including means for storing said reference signals, preferably respective frequency representations and more preferably a respective Doppler signature.

29. A system as claimed in claim 19, wherein reference signals include respective reference signals representing a plurality of target types, and optionally one or more anticipated false alarm types, respective such reference signatures preferably being provided or respective intervals of baseline crossing data.

30. A system as claimed in claim 1, wherein, in order to determine a location at which said target crosses a notional baseline between the nodes of a pair, the system is configured to determine from the respective signals received at each node a respective baseline crossing location, and to select one or other of said respective baseline crossing location as an actual baseline crossing location depending on the relative amplitude of the received signals at each node in respect of the target.

31. A system as claimed in claim 30, wherein the system is configured to calculate for each of said respective baseline crossing locations at which of said nodes the amplitude of said received signal is expected to be higher, to measure the actual amplitude of said received signal at each node and to select one or other of said respective baseline crossing location as the actual baseline crossing location depending on said measured and said expected amplitudes.

32. A system as claimed in claim 30, wherein determining said baseline crossing location, preferably a baseline crossing point and a baseline crossing angle, involves comparing the phase variation in the received time domain signal with a respective expected phase variation for one or more reference target speed, baseline crossing point and/or baseline crossing angle.

33. A system as claimed in claim 1, wherein said wireless communication means is configured to supporting a bidirectional radar communication link, said wireless signals comprising radar signals.

34. A system as claimed in claim 1, wherein said radar link is a forward scatter radar link.

35. A system as claimed in claim 1, wherein said wireless communication means is configured to transmit continuous wave wireless signals.

36. A system as claimed in claim 1, wherein, when said target is in said detection zone, said received signal includes a multipath signal reflected from said target, and wherein the analysing means of one or both nodes of a pair, or other system components, is configured to analyse one or more characteristics of said multi-path signal.

37. An intruder detection method for use in an intruder detection system comprising at least one pair of detection nodes, each node comprising wireless communication means for supporting a bidirectional wireless communication link, the method comprising sending a wireless signal to and receiving a wireless signal from the other paired node across said link to create an electromagnetic field defining a detection zone between the paired nodes; and analysing said wireless signal received from the other node of the pair to detect one or more characteristics of said received signal that is indicative of a disturbance in said electromagnetic field caused by the presence of a target in said detection zone.
